(19) United States
(12) Patent Application Publication
(10) Pub. No.: US 2006/0262452 A1
(43) Pub. Date: Nov. 23, 2006

(54) Method of making hermetically sealed hard disk drive by encapulation

(75) Inventors: Andrei Khurshudov, San Jose, CA (US); George Tyndall, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 11/132,852

(22) Filed: May 18, 2005

(51) Int. Cl. G11B 17/00

(52) U.S. Cl. 360/97.01

(57) ABSTRACT

An encapsulated hard disk drive. The drive includes a spindle motor and an actuator arm assembly coupled to a base plate. A disk and head are coupled to the spindle motor and actuator arm assembly, respectively. A cover encloses the disk and the head. The cover and the base plate are covered with an encapsulant. The encapsulant may be a dip coated polymer that can flow into every crack and aperture of the cover and base plate to hermetically seal the disk drive.

### BACKGROUND OF THE INVENTION

1. Field of the Invention

The present invention relates to a hard disk drive.

2. Background Information

Hard disk drives contain a plurality of magnetic heads that are coupled to rotating disks. The heads can magnetize and sense the magnetic fields of the disks to write and read data, respectively. The heads each have an air bearing surface that cooperates with a flow of air generated by the rotating disk to create an air bearing. The air bearing prevents mechanical wear between the head and the disk.

The air bearing is very small typically on the order of tens of nanometers. Any particles or contamination that becomes deposited on the disk may cause undesirable disturbances in the flying head. To minimize contaminants the disk drive may contain seals and a filter(s). No seal or filter system is full proof. Consequently, particles and other contaminants can still infiltrate the disk drive and become deposited on the disk. It would be desirable to completely seal the disk drive after assembly.

### BRIEF SUMMARY OF THE INVENTION

An encapsulated hard disk drive. The drive includes a spindle motor and an actuator arm assembly coupled to a base plate. A disk and head are coupled to the spindle motor and actuator arm assembly, respectively. A cover encloses the disk and the head. The cover and the base plate are covered with an encapsulant.

### BRIEF DESCRIPTION OF THE DRAWINGS

FIG. 1 is a perspective view of an embodiment of a hard disk drive;

FIG. 2 is a top sectional view of the hard disk drive;

FIG. 3 is a sectional view of the disk drive showing an encapsulant that covers an outer surface of the drive;

FIG. 4 is a schematic of an electrical circuit for the hard disk drive.

### DETAILED DESCRIPTION

Disclosed is an encapsulated hard disk drive. The drive includes a spindle motor and an actuator arm assembly coupled to a base plate. A disk and head are coupled to the spindle motor and actuator arm assembly, respectively. A cover encloses the disk and the head. The cover and the base plate are covered with an encapsulant. The encapsulant may be a dip coated polymer that can flow into every crack and aperture of the cover and base plate to hermetically seal the disk drive.

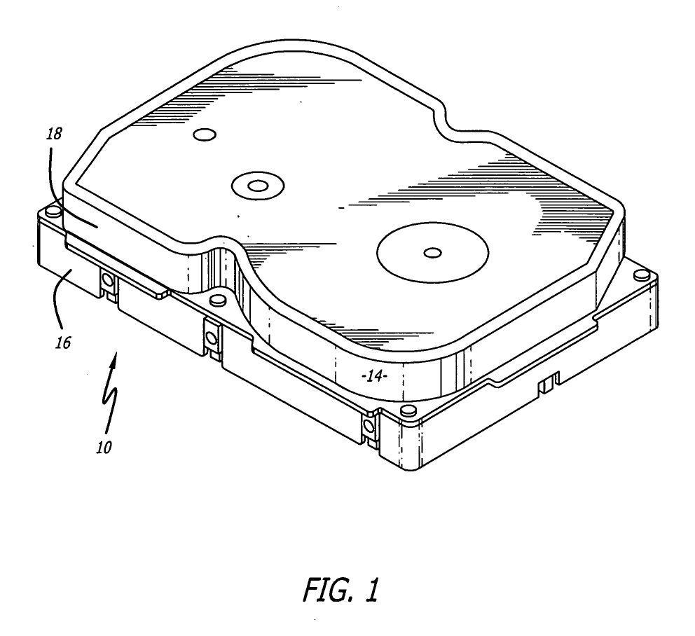

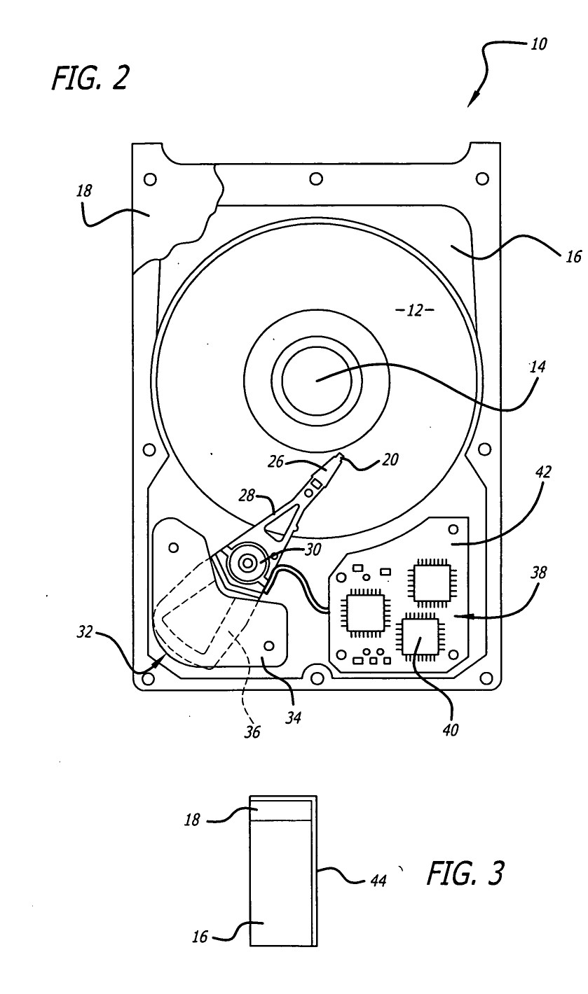

Referring to the drawings more particularly by reference numbers, FIGS. 1 and 2 show an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a corresponding flexure arm 26. The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14. The cover 18 and base plate 16 enclose the disk 12 and heads 20 of the disk drive 10.

As shown in FIG. 3, the outer surface of the base plate 16 and cover 18 may be covered with an encapsulant 44. By way of example, the encapsulant 44 may be a polymer material such as a polyurethane. The polymer encapsulant may be applied to the disk drive housing in a number of ways. For example, if the glass transition temperature of the polymer is greater than the maximum operating temperature of the disk drive, the drive can be dipped into a bath of melted polymer and then allowed to dry. Dipping the disk drive into the molten bath allows the liquid polymer to flow into the cracks and holes of the drive. The dipping process thus completely seals the disk drive with an outer coat of encapsulant. The encapsulant is typically relatively thin. By way of example, the thickness of the encapsulant may be 5 millimeters thick or less.

If the glass transition temperature of the polymer is below the maximum operating temperature of the drive, then the polymer may be cured after the dipping process. The polymer may be cured using various cross-linking techniques such as UV exposure, thermal annealing, electron bombardment, etc. The polymer may be mixed with a solvent that is then subsequently removed after dipping the drive into the polymer/solvent solution. The drive may be dip coated in a monomeric precursor that contains an easily polymerizable moiety. Polymerization of the deposited monomer film is then carried out using any suitable means of initiation. As yet another alternative, the disk drive may be encapsulated with a vapor deposition process. The vapor deposition process may allow for the deposition of various types of materials, including organic, organo-silicone, or a metal.

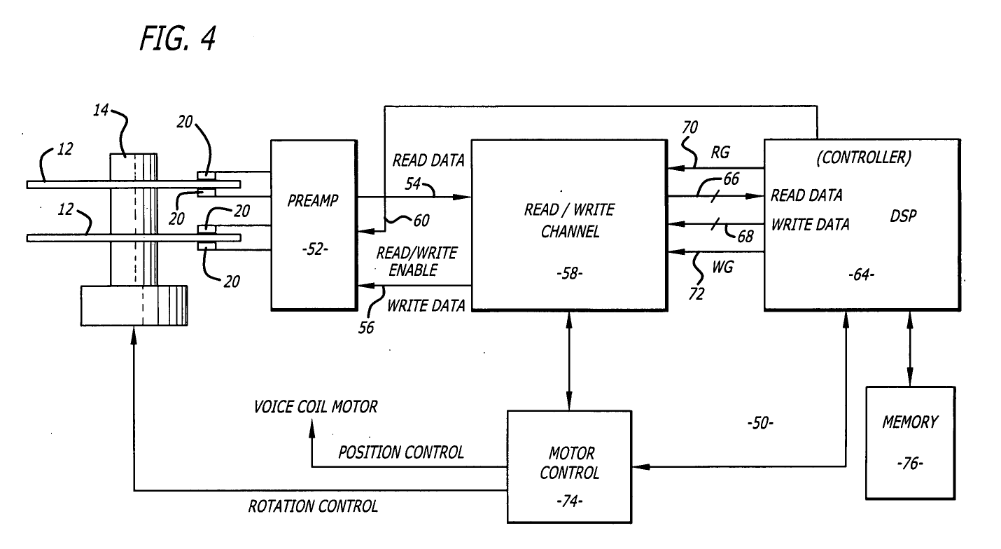

FIG. 4 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine(s), including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the firmware and/or software routine(s) performed by the controller.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate;
a spindle motor coupled to said base plate;
a disk coupled to said spindle motor;
an actuator arm assembly coupled to said base plate;
a head structurally coupled to said actuator arm assembly and magnetically coupled to said disk;
a cover that is attached to said base plate and encloses said disk and said head; and,
an encapsulant that covers said cover and said base plate.

2. The disk drive of claim 1, wherein said encapsulant is a polymer material.

3. The disk drive of claim 2, wherein said polymer is dip coated onto said base plate and said cover.

4. The disk drive of claim 1, wherein said encapsulation has a thickness of 5 millimeters or less.

5. The disk drive of claim 1, wherein said encapsulant has a glass transition temperature greater than a maximum operating temperature of the hard disk drive.

6. The disk drive of claim 2, wherein said polymer is a polyurethane.

7. A hard disk drive, comprising:
a base plate;
a spindle motor coupled to said base plate;
a disk coupled to said spindle motor;
an actuator arm assembly coupled to said base plate;
a head structurally coupled to said actuator arm assembly and magnetically coupled to said disk;
a cover that is attached to said base plate and encloses said disk and said head; and,
sealing means for sealing said cover and said base plate.

8. The disk drive of claim 7, wherein said sealing means includes is a polymer material.

9. The disk drive of claim 8, wherein said polymer is dip coated onto said base plate and said cover.

10. The disk drive of claim 7, wherein said sealing means has a thickness of 5 millimeters or less.

11. The disk drive of claim 7, wherein said sealing means has a glass transition temperature greater than a maximum operating temperature of the hard disk drive.

12. The disk drive of claim 8, wherein said polymer is a polyurethane.

13. A method for assembling a hard disk drive, comprising:
attaching a cover to a base plate to enclose a disk and a head of a hard disk drive; and,
encapsulating the cover and the base plate.

14. The method of claim 13, wherein the cover and the base plate are encapsulated by dipping the cover and the base plate into a bath of liquid polymer.

15. The method of claim 14, wherein the polymer has a glass transition temperature above a maximum operating temperature of the disk drive.

16. The method of claim 13, wherein the cover and the base plate are encapsulated with a material that is applied in a vapor form.
